(19) United States
(12) Patent Application Publication
(10) Pub. No.: US 2007/0070009 A1
(43) Pub. Date: Mar. 29, 2007

(54) Display device

(76) Inventors: Ikuko Mori, Chiba (JP); Ryutaro Oke, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/525,834

(22) Filed: Sep. 25, 2006

(30) Foreign Application Priority Data
Sep. 29, 2005 (JP) 2005-283272

(51) Int. Cl. G09G 3/36

(52) U.S. Cl. 345/89

(57) ABSTRACT

An afterimage produced when a hold response display is used in an I/P conversion display mode is reduced. This is achieved by a display device comprising: a plurality of drain electrode lines and a plurality of gate electrode lines arranged in a matrix; and pixel areas, each surrounded by two adjacent drain electrode lines and two adjacent gate electrode lines, each pixel area having a TFT element, the assembly of the pixel areas defining a display area, a drain electrode of the TFT element electrically connected to the drain electrode line, a source electrode of the TFT element electrically connected to a pixel electrode, a signal of positive polarity and a signal of negative polarity alternately applied to the pixel electrode a first frame number of times, wherein there is provided a specific period in which a signal of same polarity is applied in succession to the pixel electrode a second frame number of times that is greater than the first frame number, and in the specific period, a signal of a gray scale level lower than those in the first half and second half of the frames is applied.

### CLAIM OF PRIORITY

The present application claims priority from Japanese application serial No. 2005-283272, filed on (Sep. 29, 2005), the content of which is hereby incorporated by reference into this application.

### BACKGROUND OF THE INVENTION

1. Field of the Invention

The present invention relates to a display device, and particularly to a technology that is effective when applied to a hold-type display device with TFT (thin film transistor) elements arranged in a matrix on a pixel basis.

2. Description of the Related Art

Conventionally, a display is roughly divided into an impulse response display and a hold response display, when classified in terms of displaying motion image. The impulse response display is characterized in that the brightness responds such that it decreases immediately after the scan, for example, as with afterglow characteristics of a cathode ray tube. The hold response display is characterized in that the brightness based on display data is maintained until the next scan, for example, as in a liquid crystal display.

A representative example of the display that requires displaying motion image is a television receiver. When the television receiver is a hold response display, it uses, for example, interlace/progressive conversion (I/P conversion) to display motion images (video images).

In the I/P conversion, for example, the horizontal lines of a frame on a display panel are displayed such that an odd-numbered line is displayed based on display data inputted from an external system, while an even-numbered line is displayed at gray scale levels produced by averaging the gray scale levels of the display data of the previous and subsequent odd-numbered lines. In the next frame, an even-numbered line is displayed based on display data inputted from the external system, while an odd-numbered line is displayed at gray scale levels produced by averaging the gray scale levels of the display data of the previous and subsequent even-numbered lines. In the I/P conversion, the display data inputted from the external system are displayed in a pseudo manner by repeating the above procedure.

However, when the I/P conversion is used to display images, for example, an afterimage disadvantageously occurs at the boundary between two areas that greatly differ in gray scale level of display data, resulting in significantly degraded display quality. This problem will be briefly described with reference to the drawings.

Suppose the image to be displayed using the I/P conversion is, for example, a monochromatic image 5 as shown in FIG. 12. The I/P conversion converts an interlaced (thinned out) image to a progressive (sequentially scanned) image. The upper left view of FIG. 13 shows input information for an even frame, while the upper right view of FIG. 13 shows input information for an odd frame. The areas surrounded by dotted lines represent externally inputted signals. Since information carried by a line between the dotted areas is not externally supplied, it is required to internally produce the information for that line. The I/P conversion is used for this purpose. As one example, when same image information is inputted to the pixels of one line and to the pixels of the next line in the scan direction, the pixels between these lines are set such that they have the same information. On the other hand, when the information inputted to the pixels of one line differs from that inputted to the pixels of the next line, it is required to internally produce some data, which may be an averaged data, by way of example. The lower left view of FIG. 13 shows a post-I/P conversion progressive image for an even frame, while the lower right view of FIG. 13 shows a post-I/P conversion progressive image for an odd frame.

In this case, the boundary between the white area 5a and the black area 5b in the image 5 shown in FIG. 12 corresponds to HL3 in FIG. 13, which is produced for input data for even-numbered lines. Each pixel of HL3 is displayed at an intermediate gray scale level produced by averaging the gray scale level (white) of the pixels of the horizontal line HL2 and the gray scale level (black) of the pixels of HL4. Similarly, for input data for odd-numbered lines, each pixel of HL4 is displayed at an intermediate gray scale level produced by averaging the gray scale level (white) of the pixels of the horizontal line HL3 and the gray scale level (black) of the pixels of HL5.

A generally known method for driving a display device is a dot inversion drive method in which positive polarity (+) and negative polarity (−) alternate for each frame. In this method, the pixels of the horizontal line HL3 shown in FIG. 13 alternately receive an intermediate gray scale voltage of positive polarity and a white gray scale voltage of negative polarity, or an intermediate gray scale voltage of negative polarity and a white gray scale voltage of positive polarity in succession. Consequently, a direct current is applied to the horizontal line HL3, so that the pixels of the horizontal line HL3 get whitish when displayed at the intermediate gray scale level.

Similarly, the pixels of the horizontal line HL4 alternately receive a black gray scale level voltage of positive polarity and an intermediate gray scale voltage of negative polarity, or a black gray scale voltage of negative polarity and an intermediate gray scale voltage of positive polarity in succession. Consequently, a direct current is applied to the horizontal line HL4, so that the pixels of the horizontal line HL4 get whitish when displayed at the intermediate gray scale level. These direct currents cause afterimages.

As a method to solve the above problem, there is a known three-dimensional I/P conversion method in which information carried by a plurality of frames are integrated to produce complementary information. This method, however, disadvantageously requires at least a frame memory corresponding to the size of the screen, resulting in increased cost.

### SUMMARY OF THE INVENTION

An object of the invention is to provide a technology capable of reducing an afterimage in an inexpensive manner when a hold response display is used in an I/P conversion display mode.

These and other objects and novel features of the invention will become apparent from the following description herein and accompanying drawings.

The invention disclosed in this application is summarized as follows:

(1) According to an aspect of the invention, there is provided a display device comprising: a plurality of drain electrode lines and a plurality of gate electrode lines arranged in a matrix; and pixel areas, each surrounded by two adjacent ones of the drain electrode lines and two adjacent ones of the gate electrode lines, each pixel area having a TFT element, the assembly of the pixel areas defining a display area, a drain electrode of the TFT element electrically connected to the drain electrode line, a source electrode of the TFT element electrically connected to a pixel electrode, a signal of positive polarity and a signal of negative polarity alternately applied to the pixel electrode a first frame number of times, wherein there is provided a specific period in which a signal of same polarity is applied in succession to the pixel electrode a second frame number of times that is greater than the first frame number, and in the specific period, a signal of a gray scale level lower than those in the first half and second half of the frames is applied.

(2) In the display device described in (1), a scan signal is applied in the period in which the signal of a lower gray scale level is applied.

(3) In the display device described in (1) or (2), for a frame other than those in the specific period, a signal of a gray scale level lower than that of a signal in the frame is applied in the latter part of the frame.

(4) According to another aspect of the invention, there is provided a display device comprising: a plurality of drain electrode lines and a plurality of gate electrode lines arranged in a matrix; and pixel areas, each surrounded by two adjacent ones of the drain electrode lines and two adjacent ones of the gate electrode line, each pixel area having a TFT element, the assembly of the pixel areas defining a display area, a drain electrode of the TFT element electrically connected to the drain electrode line, a source electrode of the TFT element electrically connected to a pixel electrode, a signal of positive polarity and a signal of negative polarity alternately applied to the pixel electrode a first frame number of times, wherein there is provided a specific period in which a signal of same polarity is applied in succession to the pixel electrode a second frame number of times that is greater than the first frame number, and in the specific period, a signal with brightness lower than that in the first half and second half of the frames is applied.

(5) In the display device described in (4), a scan signal is applied in the period in which the signal with lower brightness is applied.

(6) In the display device described in (4) or (5), for a frame other than those in the specific period, a signal with brightness lower than that of a signal in the frame is applied in the latter part of the frame.

In the display device of the invention, as described with reference to the device of (1), when the signal of positive polarity and the signal of negative polarity are alternately applied the first frame number of times, there is first provided the specific period in which the signal of either polarity is applied in succession the second frame number of times that is greater than the first frame number. In this way, the order of the polarity of the voltage on the pixel electrode of each TFT element with respect to the voltage of the common electrode, that is the phase of the voltage on the pixel electrode, can be inverted. Thus, for example, a pixel to which a white gray scale signal of positive polarity and an intermediate gray scale signal of negative polarity are alternately applied for a certain period will alternately receive a white gray scale signal of negative polarity and an intermediate gray scale signal of positive polarity at some point of time, thereby preventing direct current application resulting from the continuous application of the white gray scale signal of positive polarity and hence reducing an afterimage in the I/P conversion display mode.

Furthermore, in the specific period in which the signal of same polarity is applied in succession in order to invert the phase, a signal of a gray scale level lower than those of the first half and second half of the frames is applied, thereby reducing the brightness when the second half of the frames starts. If the second frame number is 2, for example, a signal of the minimum gray scale level or a signal of a gray scale lower than that of the first one frame is applied Δt seconds before the first frame ends and the pixel displays that gray scale level, thereby reducing the brightness when the second one frame starts. This can prevent a transient change in brightness resulting from increased brightness of the second frame due to continuous application of the signal of same polarity, that is, as a visual phenomenon, a flashing phenomenon that appears brighter from time to time.

Furthermore, as described with reference to the device of (2), the scan signal is applied in the period in which the signal of a lower gray scale in the specific period is applied, thereby preventing only the flashing phenomenon in the specific period in an efficient manner.

The signal of a lower gray scale level may be applied not only in the specific period but also, for example, in the latter part of a frame other than those in the specific period, as described with reference to the device of (3). Furthermore, the scan signal is applied only in the period in which the signal of a lower gray scale level in the specific period is applied, thereby providing the same effect as those in the devices of (1) and (2). Moreover, applying the scan signal in the period in which the signal of a lower gray scale level is applied also for the frames other than those in the specific period also serves to insert a black screen in each of the frames, for example, reducing motion image blur resulting from retinal afterimage.

As the afterimage and the flashing phenomenon in the I/P conversion display mode can be reduced by changing data, an expensive frame memory is not required, so that there is no increase in cost.

Although in the devices of (1) to (3), a signal of a gray scale level lower than those of the first half and second half of the frames is applied in the specific period, a signal of lower brightness, instead of the signal of a lower gray scale level, may be applied. This results in the devices of (4) to (6), providing the same effect as those in the devices of (1) to (3).

### BRIEF DESCRIPTION OF THE DRAWINGS

FIG. 1 shows an overall circuit configuration of a display device to which the invention is applied;

FIG. 2 shows a circuit configuration of one pixel of the display device to which the invention is applied;

FIG. 3 is a diagrammatic view for explaining the operation of a conventional general display device in comparison with the invention, showing the signal applied to the drain electrode, the scan signal applied to the gate electrode line and the potential on the pixel electrode in relation to the common voltage;

FIG. 4 is a diagrammatic view for explaining the operation of the conventional general display device in comparison with the invention, showing the relationship between the potential on the pixel electrode and the brightness;

FIG. 5 is a diagrammatic view for explaining a displaying method for reducing an afterimage due to I/P conversion, showing the relationship among the signal applied to the drain electrode, the scan signal applied to the gate electrode line, and the potential on the pixel electrode;

FIG. 6 is a diagrammatic view for explaining the displaying method for reducing an after image due to I/P conversion, showing the relationship between the potential on the pixel electrode and the brightness;

FIG. 7 is a diagrammatic view for explaining the displaying method for reducing an afterimage due to I/P conversion, showing the changes in brightness and polarity of the pixel;

FIG. 8 is a diagrammatic view for explaining a displaying method for a display device according to one example of the invention, showing the relationship among the signal applied to the drain electrode, the scan signal applied to the gate electrode line and the potential on the pixel electrode;

FIG. 9 is a diagrammatic view for explaining the displaying method for a display device according to one example of the invention, showing the relationship between the potential on the pixel electrode and the brightness;

FIG. 10 is a diagrammatic view for explaining a variation of the above example, showing the signal applied to the drain electrode, the scan signal applied to the gate electrode line, and the potential on the pixel electrode in relation to the common voltage;

FIG. 11 is a diagrammatic view for explaining the variation of the above example, showing the relationship between the potential on the pixel electrode and the brightness;

FIG. 12 is a diagrammatic view showing one example of an image to be displayed by a display device; and

FIG. 13 is a diagrammatic view for explaining a displaying method based on I/P conversion.

### DESCRIPTION OF THE PREFERRED EMBODIMENTS

The invention will be described below in detail along with embodiments (examples) thereof with reference to the drawings. Throughout the drawings for explaining the examples, those having same functions have same reference characters and redundant description thereof will be omitted.

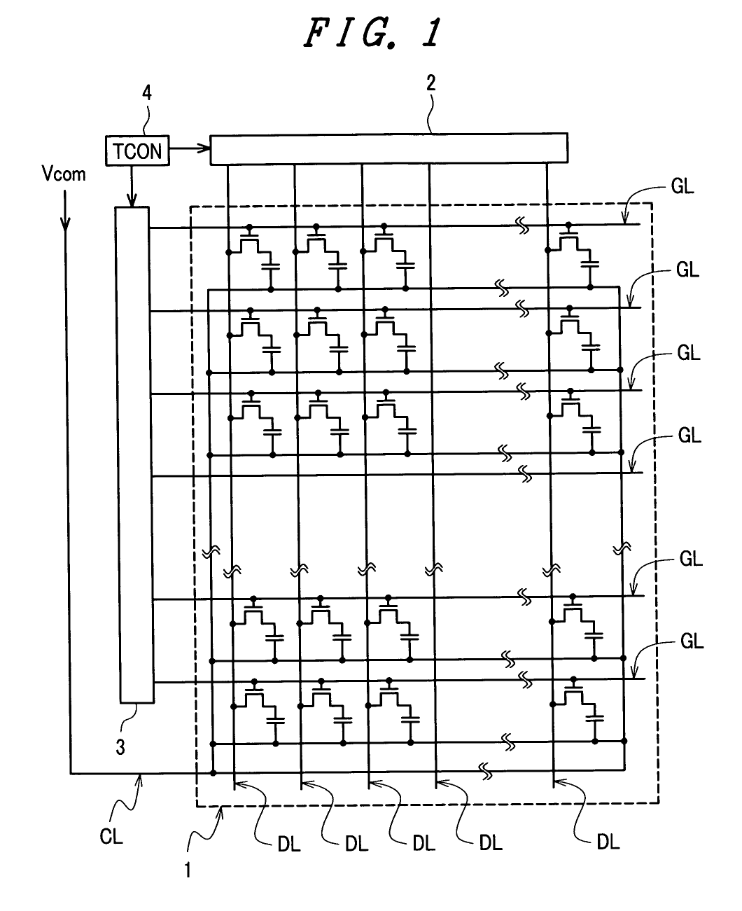

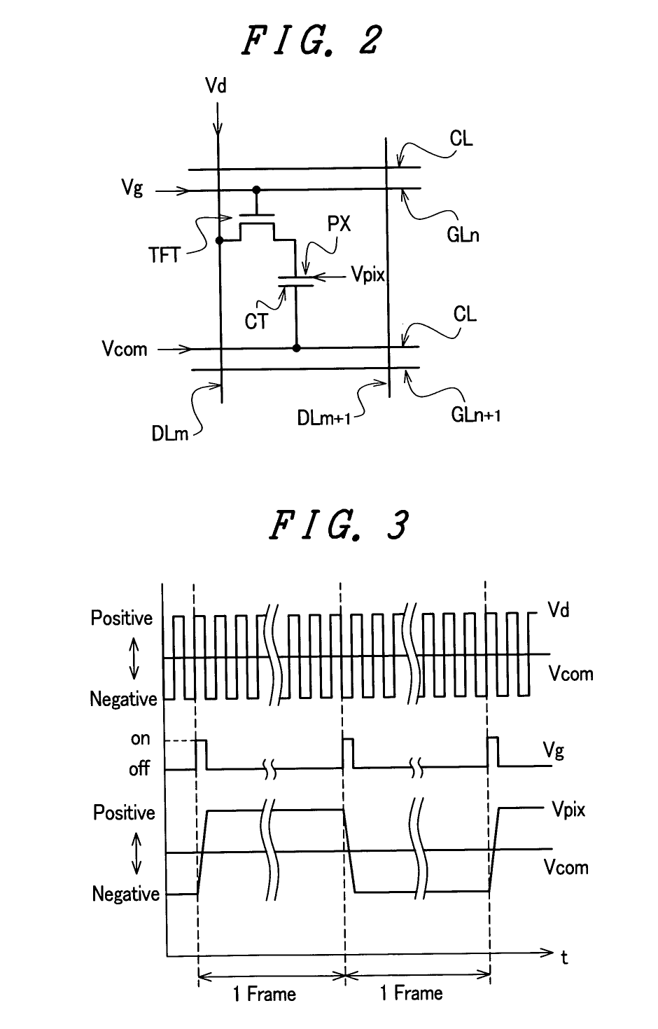

FIGS. 1 and 2 are diagrammatic views showing one example of a circuit configuration of a display device to which the invention is applied. FIG. 1 shows an overall circuit configuration and FIG. 2 shows a circuit configuration of one pixel.

The display device to which the invention is applied has a plurality of drain electrode lines DL and a plurality of gate electrode lines GL arranged in a matrix in a display area 1, for example as shown in FIG. 1. The drain electrode lines DL are connected to a data driver 2, while the gate electrode lines GL are connected to a scan driver 3. The area surrounded by two adjacent drain electrode lines DL and two adjacent gate electrode lines GL is a pixel area and each pixel area has a TFT element.

The data driver 2 and the scan driver 3 are connected to a timing controller (TCON) 4 and apply signals to the drain electrode lines DL and the gate electrode lines GL, respectively, based on control signals from the timing controller 4.

The gate electrode of the TFT element in each pixel area is connected to one gate electrode line GLn, while the drain electrode of the TFT element is connected to one drain electrode line DLm, as shown in FIG. 2. The source electrode of the TFT element is connected to a pixel electrode PX. The pixel electrode forms capacitance with respect to a common electrode CT or a common signal line CL to which a common voltage Vcom is supplied.

FIGS. 3 and 4 are diagrammatic views for explaining the operation of a conventional general display device in comparison with the invention. FIG. 3 shows the signal applied to the drain electrode, a scan signal applied to the gate electrode line and the voltage on the pixel electrode in relation to the common voltage. FIG. 4 shows the brightness in relation to the voltage on the pixel electrode and the common voltage.

In the display device having the circuit configuration shown in FIGS. 1 and 2, the drain electrode line DL alternately receives, for example, gray scale voltage signals of positive and negative polarities with reference to the common voltage Vcom, as shown in FIG. 3. When the scan signal is inputted from the gate electrode line GL in synchronization with the start time of a frame period, the pixel electrode PX receives a signal of positive or negative polarity with reference to the common potential Vcom depending on the polarity of the gray scale voltage signal applied to the drain electrode of the TFT element at the time when the scan signal is inputted. In a conventional general liquid crystal display device, the polarity of the potential Vpix on the pixel electrode with reference to the common potential Vcom (hereinafter simply referred to as the polarity of the potential Vpix on the pixel electrode) is inverted for each frame, for example as shown in FIG. 3. If the display device is a liquid crystal display device, the state of the liquid crystal material changes according to the absolute value of the potential difference between the potential Vpix on the pixel electrode and the common potential and the pixel is displayed at a predetermined brightness (gray scale).

FIG. 4 shows an example of the relationship between the voltage Vpix on the pixel electrode and the brightness of the pixel. That is, the brightness slightly decreases at the beginning of a frame and then gradually increases to a value according to the absolute value of the voltage difference between the voltage Vpix and Vcom.

However, in the display device using the displaying method shown in FIGS. 3 and 4, using I/P conversion to display images (motion images) disadvantageously results in degraded display quality, for example, due to an afterimage.

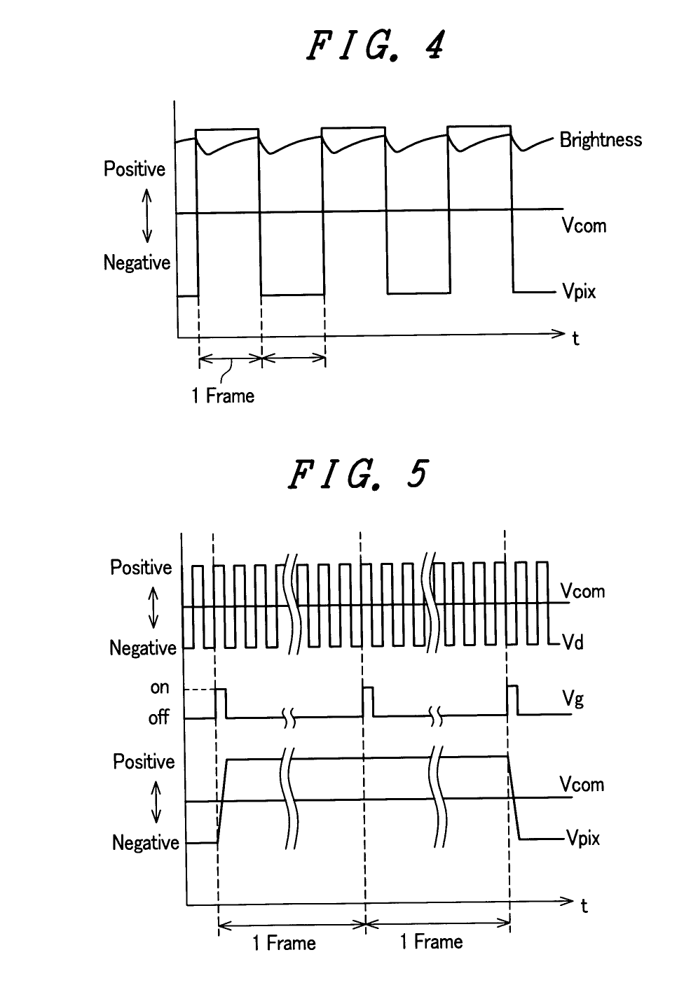

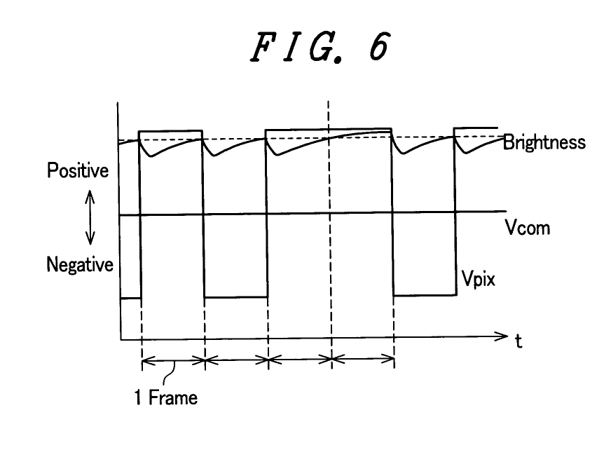

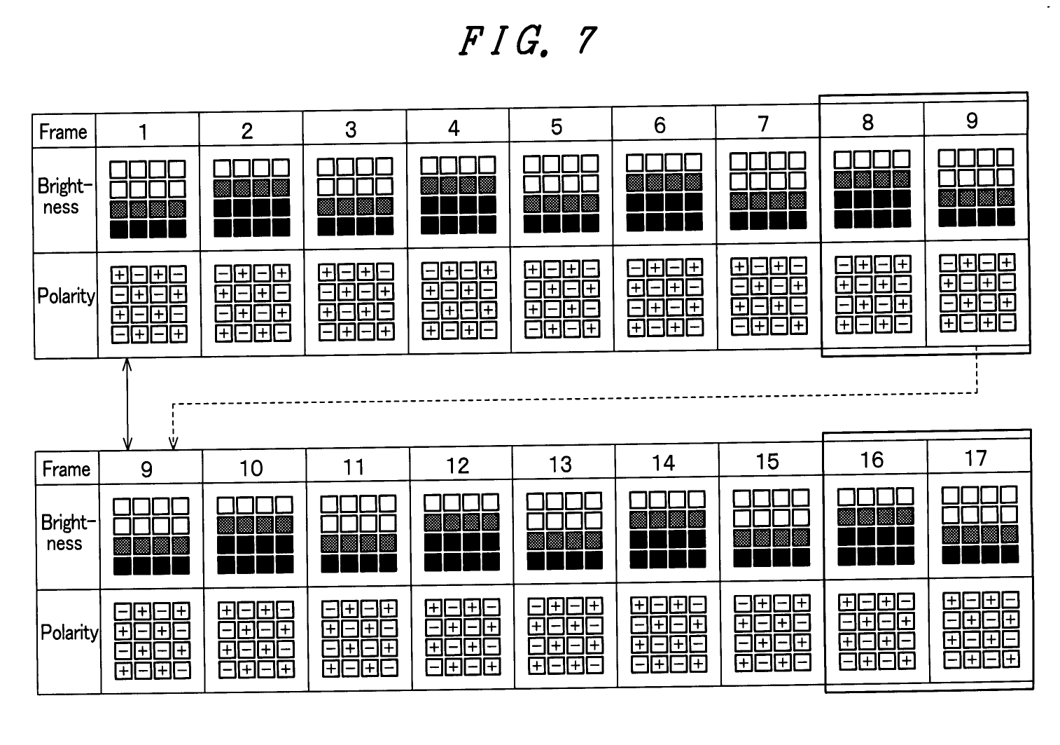

FIGS. 5 to 7 are diagrammatic views for explaining a displaying method for reducing an afterimage due to I/P conversion. FIG. 5 shows the relationship among the signal applied to the drain electrode, the scan signal applied to the gate electrode line, and the potential on the pixel electrode. FIG. 6 shows the relationship between the potential on the pixel electrode and the brightness. FIG. 7 shows the changes in brightness and polarity of the pixel.

The afterimage due to I/P conversion results from the fact that the polarity of the voltage Vpix on the pixel electrode is inverted for each frame, while, for example, a white gray scale level of positive polarity and an intermediate gray scale level of negative polarity are applied in succession, resulting in application of a direct current. To prevent such direct current application, for example, as shown in FIGS. 5 and 6, a gray scale voltage signal Vd is applied to the drain electrode DL such that the polarity of the voltage Vpix on the pixel electrode not only alternates between positive and negative, but also becomes positive in succession at some point of time in order to invert the phase of the voltage Vpix on the pixel electrode.

The phase of the voltage Vpix on the pixel electrode is inserted, for example, at every eighth frame, as shown in FIG. 7. In rows illustrating pixel brightness in FIG. 7, an open square represents a pixel of a white brightness level, and a filled square represents a pixel of a black brightness level, and a gray square represents a pixel of an intermediate brightness level. In rows illustrating the polarity of the voltage Vpix, the square with the plus sign represents a pixel of positive polarity and the square with the minus sign represents a pixel of negative polarity.

In the example shown in FIG. 7, among the frames from the first to eighth frames, the brightness and polarity of the pixels in odd frames coincide with each other, while the brightness and polarity of the pixels in even frames coincide to each other. Thus, a direct current is applied to the pixels that display an intermediate gray scale level, that is, the pixels of the two mid rows of the horizontal lines in each frame, so that an afterimage occurs if no measure is taken. When the phase is inverted in the ninth frame, the brightness of each pixel in the first frame coincides with that in the ninth frame, but the polarities are opposite with respect to each other. The brightness of each pixel in the odd frames of the ninth to sixteenth frames coincides with that in the odd frames of the first to eighth frames, but the polarities are opposite with respect to each other. Similarly, the brightness of each pixel in the even frames of the ninth to sixteenth frames coincides with that in the even frames of the first to eighth frames, but the polarities are opposite with respect to each other. When the phase is inverted again in the seventeenth frame, the brightness and the polarity of each pixel in the seventeenth frame coincide with those in the first frame.

In this way, for example, pixels to which a direct current of positive polarity is applied in the period from the first to eighth frames receive a direct current of negative polarity in the period from the ninth to sixteenth frames. Thus, the direct current of positive polarity applied in the period from the first to eighth frames is cancelled by the direct current of negative polarity applied in the period from the ninth to sixteenth frames, so that the afterimage due to I/P conversion can be reduced.

However, in the method for inverting the phase described above, for example, the voltage Vpix on the pixel electrode is of positive polarity in two consecutive frames, as shown in FIG. 6. In this case, it has been newly found that immediately after the second half of the frame starts, the brightness does not decrease but instantaneously increases to give rise to a phenomenon called flashing.

A displaying method for not only reducing the afterimage due to I/P conversion by inverting the phase of the voltage Vpix on the pixel electrode but also preventing the flashing will be described below.

### EXAMPLE

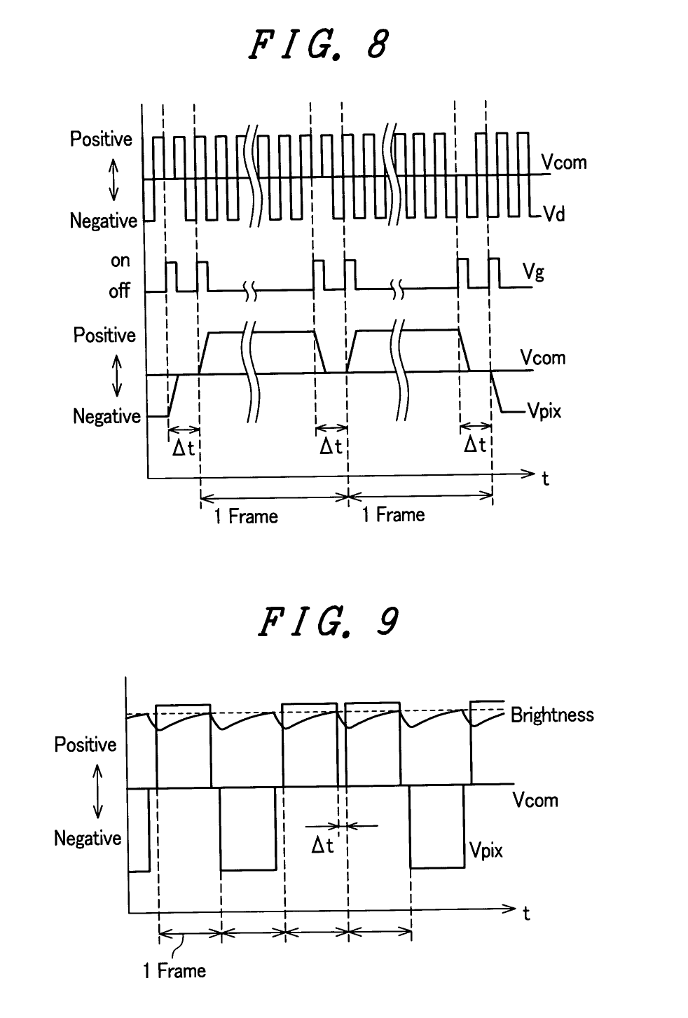

FIGS. 8 and 9 are diagrammatic views for explaining a displaying method for a display device according to one example of the invention. FIG. 8 shows the relationship among the signal applied to the drain electrode, the scan signal applied to the gate electrode line and the potential on the pixel electrode. FIG. 9 shows the relationship between the potential on the pixel electrode and the brightness.

In the displaying method of this example, the gray scale voltage signal Vd applied to the drain electrode of the TFT element in each pixel includes not only signals of positive and negative polarities but also a signal of the minimum gray scale level, that is, as one example, a signal having the same voltage as the voltage Vcom of the common signal, which is applied Δt seconds before each frame ends, as shown in FIG. 8. The scan signal is applied to the gate electrode when each frame starts as well as Δt seconds before each frame ends, that is, when the signal of the minimum gray scale level is applied to the drain electrode. In this way, as shown in FIGS. 8 and 9, for example, the voltage Vpix on the pixel electrode has a potential of positive or negative polarity depending on display data at the beginning of each frame and each pixel is displayed at a predetermined brightness (gray scale). The voltage Vpix on the pixel electrode of each pixel becomes equal to the voltage Vcom of the common signal Δt seconds before each frame ends and each pixel is displayed at the minimum gray scale level (black). Thus, for example, as shown in FIG. 9, even if consecutive frames of positive polarity are placed in order to invert the phase, each pixel is displayed at the minimum gray scale level for Δt seconds between the first half and second half of the frames, during which the brightness of each pixel decreases, thereby preventing the flashing phenomenon due to the instantaneous increase in brightness in the second half of the frames.

By applying the signal of the minimum gray scale level not only to the frame in which the phase is inverted as in this example, but also to the remaining frames Δt seconds before each frame ends, each pixel will be displayed at the minimum gray scale level for Δt seconds between the frames. This also serves to insert a black screen, for example, as described in JP-A-2004-212749, thereby reducing motion image blur resulting from retinal afterimage.

The length of the time Δt for displaying each frame at the minimum gray scale level is arbitrary determined. To reduce decrease in maximum gray scale level (white brightness), the time Δt may be shorter. To reduce the motion image blur, the time Δt may be longer.

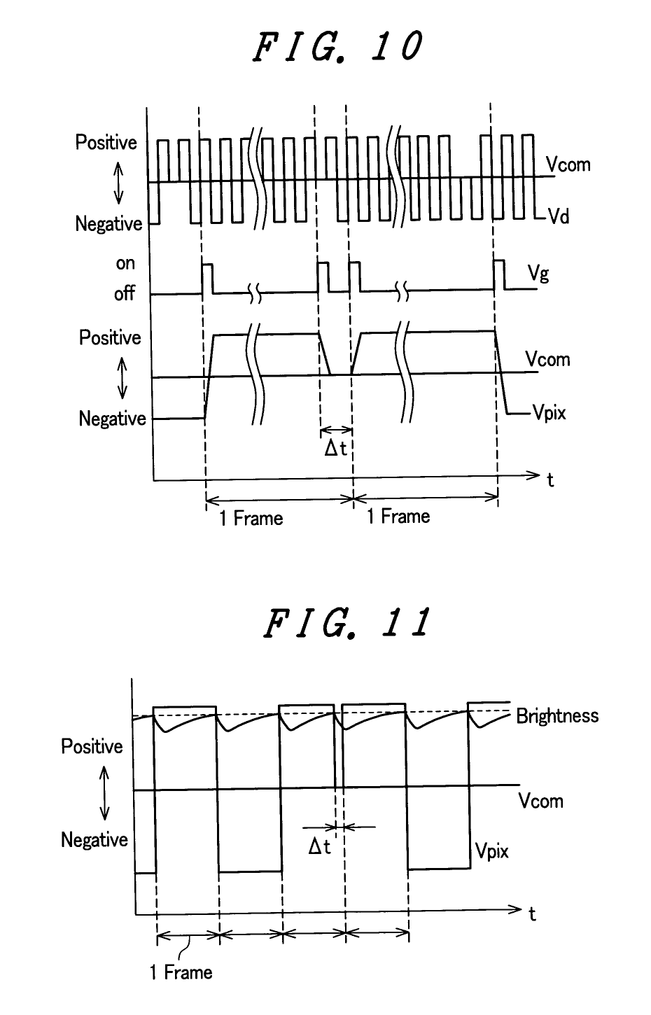

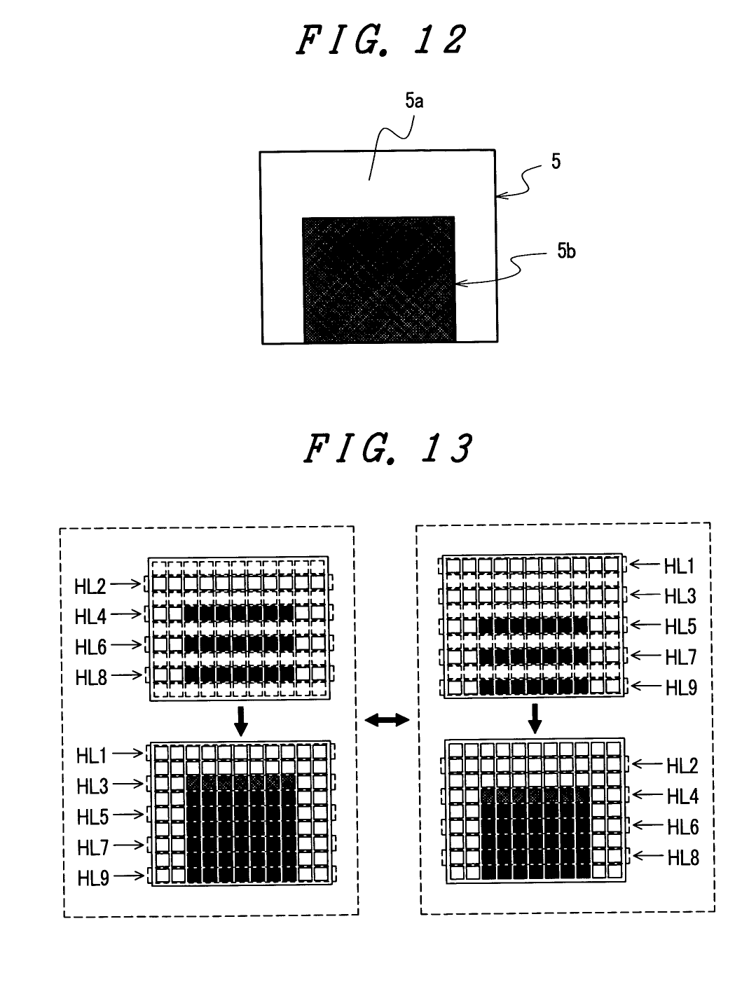

FIGS. 10 to 11 are diagrammatic views for explaining a variation of the above example. FIG. 10 shows the relationship among the signal applied to the drain electrode, the scan signal applied to the gate electrode line and the potential on the pixel electrode. FIG. 11 shows the relationship between the potential on the pixel electrode and the brightness.

In FIGS. 8 and 9, the gray scale voltage signal Vd of the minimum gray scale level is applied in each frame Δt seconds before each frame ends in order to display each pixel at the minimum gray scale level for Δt seconds. However, in terms of preventing the flashing that occurs when the phase is inverted, for example, each pixel may be displayed at the minimum gray scale level between the specific frames in which same polarity are placed in succession. By way of example, as shown in FIGS. 10 and 11, when the voltage Vpix across the storage capacitor of same polarity is applied in consecutive frames, the scan signal may be only applied Δt seconds before the first half of the frames ends to insert a period in which each pixel is displayed at the minimum gray scale level only in that frame.

In this example, the case where a period in which each pixel is displayed at the minimum gray scale level is inserted has been described. However, the object of the invention can be achieved as long as the brightness between frames where same polarity is placed in succession can be reduced. Thus, for example, a period in which each pixel is displayed at an arbitrary gray scale level, not limited to the minimum gray scale level, may be inserted as long as the gray scale level is lower than those at which each pixel is displayed in the first half and second half of the frames.

In this example, although the polarity of the potential Vpix on the pixel electrode is inverted between positive and negative in a one frame cycle, this cycle is not limited to one frame, but may be two frames, three frames or more.

In this example, although the case where the Δt-second display at the minimum gray scale level is inserted in every frame and the case where the Δt-second display at the minimum gray scale level is inserted between frames where same polarity is placed in succession are described, the way the Δt-second display at the minimum gray scale level is inserted is not limited thereto. As long as the Δt-second display at the minimum gray scale level is inserted between frames where same polarity is placed in succession, it may be inserted between the other frames in any arbitrary way.

Although the invention has been specifically described with reference to the above examples, the invention is not limited to the above examples. Various changes can be of course made thereto without departing from the spirit of the invention.

What is claimed is:

1. A display device comprising: a plurality of drain electrode lines and a plurality of gate electrode lines arranged in a matrix; and pixel areas, each surrounded by two adjacent ones of the drain electrode lines and two adjacent ones of the gate electrode lines, each pixel area having a TFT element, the assembly of the pixel areas defining a display area, a drain electrode of the TFT element electrically connected to the drain electrode line, a source electrode of the TFT element electrically connected to a pixel electrode, a signal of positive polarity and a signal of negative polarity alternately applied to the pixel electrode a first frame number of times,
wherein there is provided a specific period in which a signal of same polarity is applied in succession to the pixel electrode a second frame number of times that is greater than the first frame number, and
in the specific period, a signal of a gray scale level lower than those in the first half and second half of the frames is applied.

2. The display device according to claim 1, wherein a scan signal is applied in the period in which the signal of a lower gray scale level is applied.

3. The display device according to claim 1, wherein for a frame other than those in the specific period, a signal of a gray scale level lower than that of a signal in the frame is applied in the latter part of the frame.

4. A display device comprising: a plurality of drain electrode lines and a plurality of gate electrode lines arranged in a matrix; and pixel areas, each surrounded by two adjacent ones of the drain electrode lines and two adjacent ones of the gate electrode lines, each pixel area having a TFT element, the assembly of the pixel areas defining a display area, a drain electrode of the TFT element electrically connected to the drain electrode line, a source electrode of the TFT element electrically connected to a pixel electrode, a signal of positive polarity and a signal of negative polarity alternately applied to the pixel electrode a first frame number of times,
wherein there is provided a specific period in which a signal of same polarity is applied in succession to the pixel electrode a second frame number of times that is greater than the first frame number, and
in the specific period, a signal with brightness lower than that in the first half and second half of the frames is applied.

5. The display device according to claim 4, wherein a scan signal is applied in the period in which the signal with lower brightness is applied.

6. The display device according to claim 4, wherein for a frame other than those in the specific period, a signal with brightness lower than that of a signal in the frame is applied in the latter part of the frame.
